(19) United States
(12) Patent Application Publication
(10) Pub. No.: US 2009/0020106 A1
(43) Pub. Date: Jan. 22, 2009

(54) EXHAUST GAS RECIRCULATION SYSTEM

(76) Inventors: Tadashi Iijima, Ibaraki (JP); Hirofumi Kizawa, Tochigi (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/279,829

(22) PCT Filed: Feb. 20, 2007
(86) PCT No.: PCT/JP2007/053012

§ 371 Date: Aug. 18, 2008

(30) Foreign Application Priority Data
Feb. 22, 2006 (JP) 2006-045719

(51) Int. Cl. F02M 25/07

(52) U.S. Cl. 123/568.12

(57) ABSTRACT

An exhaust gas recirculation system having an exhaust line connected to an exhaust manifold of an engine; an intake line connected to an intake manifold of the engine; and an EGR line that intercommunicates the exhaust line and the intake line, in which a part of exhaust gas exhausted from the exhaust line is delivered to the intake line via the EGR line to be recirculated in the engine, is provided with a liquid cooling heat exchanger made of a corrosion-resistant material at downstream of an intersection with the EGR line in the intake line.

### TECHNICAL FIELD

The present invention relates to an exhaust gas recirculation system including: an exhaust line connected to an exhaust manifold of an engine; an intake line connected to an intake manifold of the engine, and an EGR line intercommunicating the exhaust line and the intake line, in which a part of exhaust gas exhausted from the exhaust line is delivered to the intake line via the EGR line to be recirculated in the engine.

### BACKGROUND ART

For purpose of lowering combustion temperature of a diesel engine to restrain generation of NOx, a so-called EGR (Exhaust Gas Recirculation) system, which delivers a part of exhaust gas exhausted from the engine to an intake line, has conventionally been known.

In the EGR system, an exhaust line connected to an exhaust manifold of the engine and the intake line connected the intake manifold are connected by an EGR line. A part of exhaust gas exhausted form the engine is delivered to the intake line via the EGR line, mixed with air delivered to the intake line, and delivered to the engine through the intake manifold.

Here, NOx reduction in such an EGR system is influenced by temperature of the mixture delivered to the intake manifold. When the temperature of the mixture is high, sufficient NOx reduction is not obtained.

To solve such a problem, an art in which the EGR line is provided with an EGR cooler, where the exhaust gas is cooled before the exhaust gas is mixed with the air delivered through the intake line and is delivered to the intake manifold (e.g., see Patent Document 1).

Patent Document: JP-T-09-508691 (FIG. 1)

### DISCLOSURE OF THE INVENTION

### Problems to Be Solved by the Invention

NOx regulation has been tightened in recent years. It is necessary to improve NOx reduction by (increasing the EGR rate by) increasing the exhaust gas returning to the intake side.

Increase in the EGR rate causes increase in the amount of the exhaust gas, which causes rise in the temperature of the mixture delivered to the intake manifold. If this is to be prevented by the art disclosed in Patent Document 1, performance of the EGR cooler needs to be greatly improved, which results in size enlargement of the EGR cooler.

Meanwhile, since an air cooling aftercooler is usually provided to the intake line, one may think of mixing the air delivered through the intake line with EGR gas before cooling by the air cooling aftercooler, so that the mixture delivered to the intake manifold is collectively cooled.

However, an air cooling aftercooler is generally made of a material such as aluminum or the like for weight reduction, so that the air cooling aftercooler is likely to be corroded by sulfur content in the EGR gas. As a consequence, the mixture can not be cooled by the air cooling aftercooler.

An object of the present invention is to provide an exhaust gas recirculation system in which size enlargement of a cooler is averted and NOx reduction is not hampered while the EGR rate is increased.

### Means for Solving the Problems

An exhaust gas recirculation system according to an aspect of the present invention includes: an exhaust line connected to an exhaust manifold of an engine; an intake line connected to an intake manifold of the engine; and an EGR line that intercommunicates the exhaust line and the intake line, in which a part of exhaust gas exhausted from the exhaust line is delivered to the intake line via the EGR line to be recirculated in the engine, and a liquid cooling heat exchanger made of a corrosion-resistant material is provided to downstream of an intersection with the EGR line in the intake line.

Here, the corrosion-resistant material that constitutes the liquid cooling heat exchanger may be any material that is not corroded by condensed water including sulfur content included in the exhaust gas. Examples of such materials include a stainless material and a steel material that have undergone surface processing such as chrome-plating or the like.

According to the aspect of the invention, the liquid cooling cooler is provided to downstream of an intersection with the EGR line in the intake line, so that mixture of air form the intake line and EGR gas from the EGR line can be efficiently cooled in the liquid cooling heat exchanger. Therefore, the EGR rate can be increased without enlarging size of the EGR cooler in the EGR line and hindering NOx reduction.

In addition, since the liquid cooling heat exchanger is made of a corrosion-resistant material the cooler is not corroded even when the mixture is directly cooled by the liquid cooling cooler.

In the above arrangement, an EGR cooler that cools the exhaust gas from the exhaust line preferably is provided to the EGR line.

With this arrangement, since the EGR cooler is provided to the EGR line, the EGR gas is forcibly to be cooled before being delivered to the intake line, thereby contributing to lowering the temperature of the mixture delivered to the intake manifold together with the liquid cooling cooler. Therefore, the EGR rate is further improved while the NOx reduction is maintained.

In the above arrangement, the liquid cooling heat exchanger preferably is connected with an engine-cooling coolant circulation line.

With this arrangement, since the liquid cooling heat exchanger is connected to the engine-cooling coolant circulation line, the mixture to the intake manifold can be cooled concurrently with cooling of the engine. Therefore, size enlargement of the system is prevented.

In the above arrangement, a radiator that radiates heat of a cooling coolant to the exterior preferably is connected to the liquid cooling heat exchanger via a coolant circulation line that delivers the coolant between the heat exchanger and the radiator, and a circulation pump preferably is provided to the coolant circulation line.

With this arrangement, the coolant flowing through the liquid cooling heat exchanger is cooled by the radiator provided separately from the radiator of the engine. Accordingly, the rise of temperature of the coolant due to cooling of the engine does not affect the cooling of the mixture. Therefore, the cooling efficiency of the liquid cooling heat exchanger is improved.

In the above arrangement, a supercharger preferably is provided to the intake line, and the EGR line preferably is connected to downstream of the intake line relative to the supercharger.

With this arrangement, the EGR line is connected to a downstream side relative to the supercharger provided to the intake line, so that air is forced to be delivered to the intake manifold by the supercharger. Accordingly, even when EGR gas is increased, the amount of air including oxygen delivered in the mixture is not decreased. Therefore, decrease in the combustion efficiency of the engine is prevented, thereby restraining generation of PM and the like.

### BRIEF DESCRIPTION OF DRAWINGS

FIG. 1 is a schematic view showing an EGR system for a diesel engine according to a first embodiment of the present invention.

FIG. 2 is a schematic cross-sectional view showing structure of an EGR cooler according to the embodiment.

FIG. 3 is a perspective view showing a heat exchanger (liquid cooling cooler) according to the embodiment.

FIG. 4 is a schematic view showing an EGR system for a diesel engine of a second embodiment of the present invention.

FIG. 5 is a perspective view showing a heat exchanger (liquid cooling cooler) according to the embodiment.

FIG. 6 is a schematic view showing an EGR system for a diesel engine according to a third embodiment of the present invention.

FIG. 7 is a schematic view showing an EGR system for a diesel engine according to a fourth embodiment of the present invention.

FIG. 8 is a schematic view showing an EGR system for a diesel engine according to a fifth embodiment of the present invention.

### EXPLANATION OF CODES

1 . . . diesel engine, 3 . . . intake line, 4 . . . exhaust line, 6 . . . turbocharger, 7 . . . EGR line, 31 . . . intake manifold, 8, 18, 18A . . . liquid cooling cooler, 41 . . . exhaust manifold, 71 . . . EGR cooler, 82, 181, 1811 . . . heat exchanger, 83, 182 . . . piping line, 51, 84 . . . pump

### BEST MODE FOR CARRYING OUT THE INVENTION

Embodiments of the present invention will be described below with reference to the drawings.

### First Embodiment

### 1. Overall Arrangement

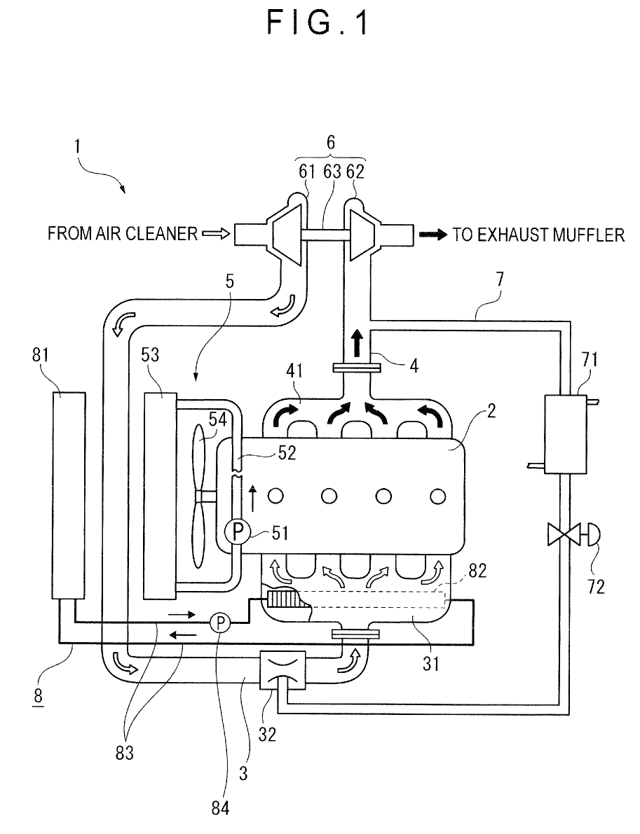

FIG. 1 is a schematic view showing an EGR system of a diesel engine (internal-combustion engine) 1 according to a first embodiment of the present invention.

The diesel engine 1 includes an in-line four-cylinder engine body 2, an intake line 3 for delivering gas to a combustion chamber, an exhaust line 4 for exhausting exhaust gas to the exterior of the combustion chamber, and an engine-cooling coolant circulation line 5 for cooling the diesel engine 1. A turbocharger 6 is provided to upstream of the intake line 3 and downstream of the exhaust line 4 in a manner linking the upstream of the intake line 3 and the downstream of the exhaust line 4. It should be noted that the above devices are controlled by an engine controller (not shown in FIG. 1) which outputs controlling signals in accordance with an operator's operation.

An intake manifold 31 is attached between the intake line 3 and the engine body 2 so that gas from the intake line 3 is distributed to each combustion chamber. An exhaust manifold 41 is attached between the engine body 2 and the exhaust line 4 so that exhaust gas from each combustion chamber is collectively flowed to the exhaust line 4.

The engine-cooling coolant circulation line 5 includes: a pump 51 driven by, for example, a crankshaft (not shown) housed in the engine body 2; a piping line 52 for circulating cooling water (coolant); and a radiator 53. Initially, the cooling water pumped by the pump 51 cools portions of the diesel engine 1 that require cooling, such as the engine body 2, the turbocharger 6, and the oil cooler (not shown) and the like. Subsequently, the cooling performance of the cooling water is enhanced at the radiator 53 provided to the engine-cooling coolant circulation line 5 by a fan 54 rotated by the crankshaft of the engine body 2.

The turbocharger 6 includes a compressor 61 provided to an intermediate portion of the intake line 3 and an exhaust turbine 62 provided to an intermediate portion of the exhaust line 4. The compressor 61 and the exhaust turbine 62 are connected by a rotation shaft 63. When exhaust gas is exhausted through the exhaust line 4, the exhaust turbine 62 rotates, which causes the compressor 61 to rotate via the rotation shaft 63. Accordingly, air delivered to the intake line 3 is compressed and delivered to the intake manifold 31, so that more air is delivered to the engine body 2, thereby improving output of the engine.

### 2. Structure of EGR Line 7

In such an arrangement of the engine 1, an EGR line 7 intercommunicates a downstream side of the intake line 3 relative to the turbocharger 6 and an upstream side of the exhaust line 4 relative to the turbocharger 6. An EGR cooler 71 and an EGR valve 72 are provided to intermediate portions of the EGR line 7.

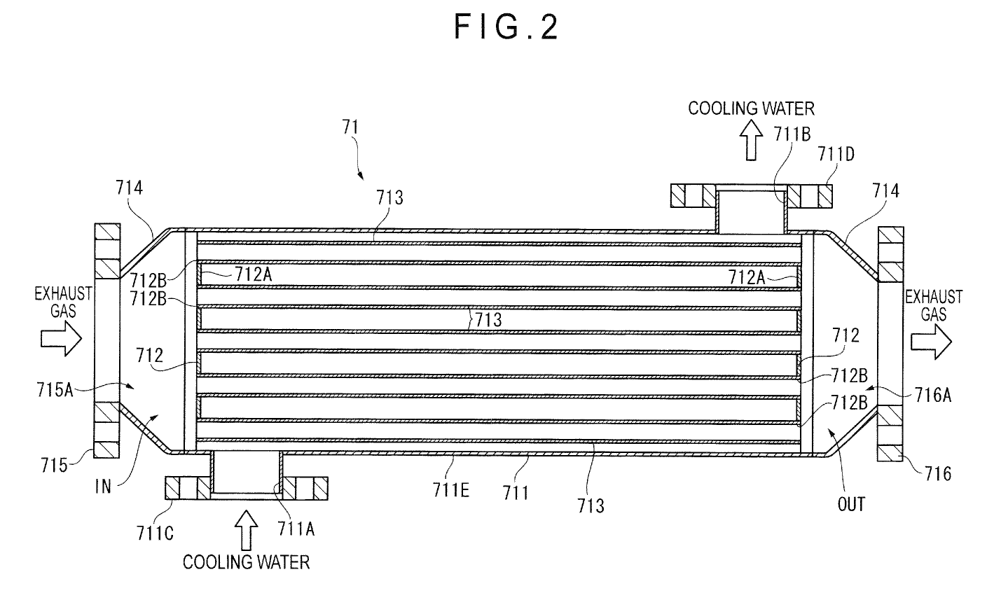

As shown in FIG. 2, the EGR cooler 71 includes: a cylindrical body 711; a pair of header plates 712 that seal openings on both sides of the body 711; a plurality of heat exchange tubes 713 which are disposed in the body 711 and whose both ends are bonded to the header plates 712 by welding or the like; and a pair of head pieces 714 bonded to end peripheries of the header plates 712 in a manner respectively covering each of the header plate 712.

A cooling water entrance 711A through which the cooling water is delivered into the body 711 is provided adjacent to a first longitudinal end of the body 711. A cooling water exit 711B through which the cooling water is delivered out of the body 711 is provided adjacent to a second longitudinal end of the body 711. The cooling water entrance 711A and the cooling water exit 711B are disposed radially opposite to each other.

The cooling water entrance 711A and the cooling water exit 711B are provided with attachment flanges 711C and 711D. Piping (not shown) for communicating with the engine side is mounted to the attachment flanges 711C and 711D. The cooling water may be, for example, a cooling water for cooling an engine.

The portion of the body 711 excluding the first and second ends is a small-diameter portion 711E having a smaller diameter than the first end and second ends. Accordingly, the cooling water delivered into the body through the cooling water entrance 711A on the first end is properly flowed into spaces between the heat exchange tubes 713 at the small-diameter portion 711E.

An air vent (not shown) for allowing air remaining inside to escape is provided to the first end at a location radially opposite to the cooling water entrance 711A.

A number of circular holes 712B are perforated on a circular attachment surface 712A of the header plate 712. The heat exchange tubes 713 are fitted to the circular holes 712B. A periphery of the circular hole 712B is bonded to an end of the heat exchange tube 713 by laser welding or the like.

An abutting flange that abuts to an inner circumference of an end of the body 711 is provided continuously in a circumferential direction on an outer circumference of the header plate 712. The flange of the header plate 712 is bonded to the body 711 by laser welding or TIG welding to fix the header plate 712 to the body 711.

Exhaust gas is flown through the heat exchange tube 713 to exchange heat with the cooling water. The heat exchange tube 713 is a straight circular tube in the embodiment.

The head piece 714 forms an entrance gas chamber IN for distributing exhaust gas to each heat exchange tube 713 at the first end of the body 711 where the cooling water entrance 711A is provided. The head piece 714 also forms an exit gas chamber OUT for gathering exhaust gas at the second end of the body 711 where the cooling water exit 711B is provided.

An attachment flange 715 to which a piping member from an exhaust side of the EGR line 7 is attached is provided to the head piece 714 at a side opposite to the portion bonded with the body 711 where the entrance gas chamber IN is formed. An attachment flange 716 to which a piping member to an intake side of the EGR line 7 is attached is provided to the head piece 714 at a side opposite to the portion bonded with the body 711 where the exit gas chamber OUT is formed.

Holes 715A and 716A are formed substantially at centers of the attachment flanges 715 and 716. The exhaust gas flowing through the EGR line 7 is delivered to the EGR cooler 71 through the hole 715A at the entrance gas chamber IN, cooled by heat change in the EGR cooler 71, exhausted through the hole 716A at the exit gas chamber OUT, and delivered to the intake line 3.

An EGR valve 72 is provided to downstream Of the EGR cooler 71. The EGR valve 72 is an electromagnetic valve that opens and closes by electric signals from the above-mentioned controller. At this time, the exhaust gas in the EGR line 7 is returned to the intake line 3 via a throttle 32, which is provided at an intersection with the intake line 3 in the intake line 3 and behaves as if swallowing the exhaust gas. The exhaust gas is then mixed with the air delivered into the intake line 3.

### 3. Structure of Liquid Cooling System 8

A liquid cooling system 8 is provided to the intake manifold 31 connected to the intake line 3. The liquid cooling system 8 is independent of the engine-cooling coolant circulation line 5 of the engine 1. The liquid cooling system 8 is a cooler including a radiator 81, a heat exchanger 82, a piping line 83, and a pump 84.

The radiator 81 has a structure substantially the same as the radiator 53 that constitutes the engine-cooling coolant circulation line 5 for cooling the engine 1. The radiator 81 is disposed in front of the radiator 53, so that the cooling performance of the radiator 81 is enhanced by the fan 54.

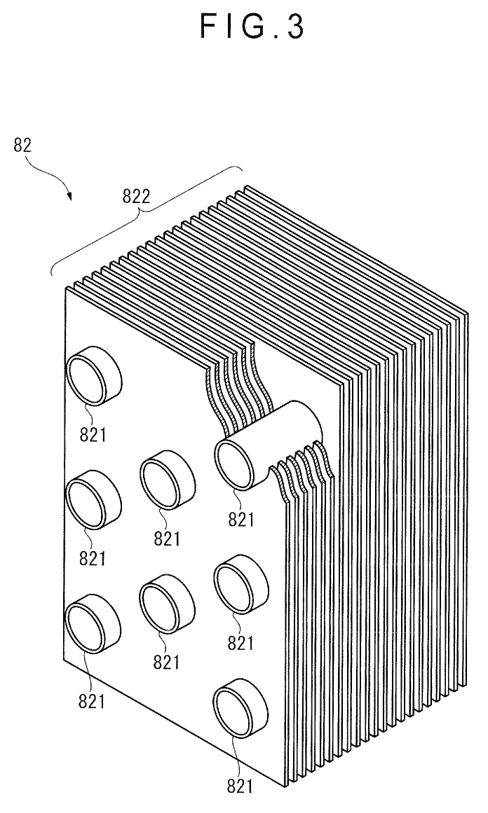

The heat exchanger 82 is provided between the intake line 3 and the intake manifold 31 and disposed inside the intake manifold 31. The heat exchanger cools the mixture delivered to the intake manifold 31. More specifically, as shown in FIG. 3, the heat exchanger 82 includes: a plurality of pipe members 821; and a plurality of fin members 822 formed by a plurality of plates provided with a plurality of holes through which the pipe members 821 are inserted. The pipe member 821 and the fin member 822 are made of a corrosion-resistant material such as SUS304 or the like. The pipe member 821 and the fin member 822 are bonded with each other by TIG welding or the like. Note that it is preferable that a length of the heat exchanger 82 be substantially the same as a length from an end of a cylinder disposed at a first end of the engine body 2 to an end of a cylinder disposed at a second end of the engine body 2.

While cooling water is circulated through the pipe member 821, the pipe member 821 and the plurality of fin members 822 are cooled. In this state, mixture delivered from the intake line 3 is delivered to spaces formed between the fin members 822, where the mixture undergoes heat exchange with the fin members 822 to be cooled, before being delivered to the intake manifold.

The piping line 83 (coolant circulation line) intercommunicates between the radiator 81 and the heat exchanger 82 in two lines. A first line 83 delivers the cooling water heated by the heat exchange in the heat exchanger 82 to the radiator 81. A second line 83 delivers the cooling water cooled by the radiator 81 to the heat exchanger 82 again.

The pump 84 (coolant circulation pump) is provided to an intermediate portion of the piping line 83 (formed in two lines) for forcing the cooling water in the piping line 83 to circulate between the radiator 81 and the heat exchanger 82.

The cooling water discharged from the pump 84 is delivered to the heat exchanger 82, where the cooling water is heated by heat exchange with the exterior via the fin while flowing through the pipe member 821. Then the cooling water is delivered to the radiator 81, where the cooling water is cooled before being delivered again to the intake side of the pump 84.

### 4. Functions and Effects of Embodiment

Next, functions of the EGR system for the diesel engine 1 having the above described structure will be described.

While the diesel engine 1 is driven, the exhaust turbine 62 of the turbocharger 6 is rotated by exhaust gas exhausted from the exhaust manifold 41. The rotation of the exhaust turbine 62 causes the compressor 61 to rotate via the rotation shaft 63, so that air supplied through the air cleaner is compressed to be delivered to the intake line 3.

When the EGR valve 72 is open, a portion of the exhaust gas exhausted from the exhaust manifold 41 is delivered through the EGR line 7 to the EGR cooler 71. The portion of the exhaust gas is then cooled by the EGR cooler 71, before being mixed with the air delivered through the air cleaner at the throttle 32 provided to the intake line 3.

The mixture is delivered to the spaces of the plurality of fin members 822 in the heat exchanger 82, where the mixture undergoes heat exchange with the fin members. After the mixture is cooled in such a manner, the mixture is supplied from the intake manifold 31 to a combustion chamber of the diesel engine 1 to be combusted.

Here, since the heat exchanger 82 of the liquid cooling system 8 is made of a corrosion-resistant material such as SUS304 or the like, the heat exchanger 82 is not corroded even when sulfur content derived from the exhaust gas is delivered to the heat exchanger 82. Accordingly, the mixture delivered to the combustion chamber of the diesel engine 1 can be combusted at sufficiently low temperature. Therefore, the EGR rate can be increased without hindering NOx reduction.

In addition, the liquid cooling system 8 is arranged in a circulation independent of the engine-cooling coolant circulation line 5 of the diesel engine 1. Accordingly, not only the mixture can be cooled effectively by deliberately controlling the cooling efficiency, but the size of the EGR cooler 71 can also be kept at a minimum.

Furthermore, the coolant of the liquid cooling system 8 is a liquid such as water or the like. Accordingly, even if the mixture remains in the heat exchanger 82 when the diesel engine 1 is stopped, the mixture is not immediately condensed to corrosive water including sulfur, since the cooling water has a larger heat capacity than coolant (air) of the air cooling system. Therefore, durability of the heat exchanger 82 is further improved.

### Second Embodiment

Next, a second embodiment of the present invention will be described. Note that the same elements as the elements already described are provided with the same numerals and omitted description thereof.

In the first embodiment, the liquid cooling system 8 is arranged in a circulation of the cooling water independent of the engine-cooling coolant circulation line 5 of the diesel engine 1.

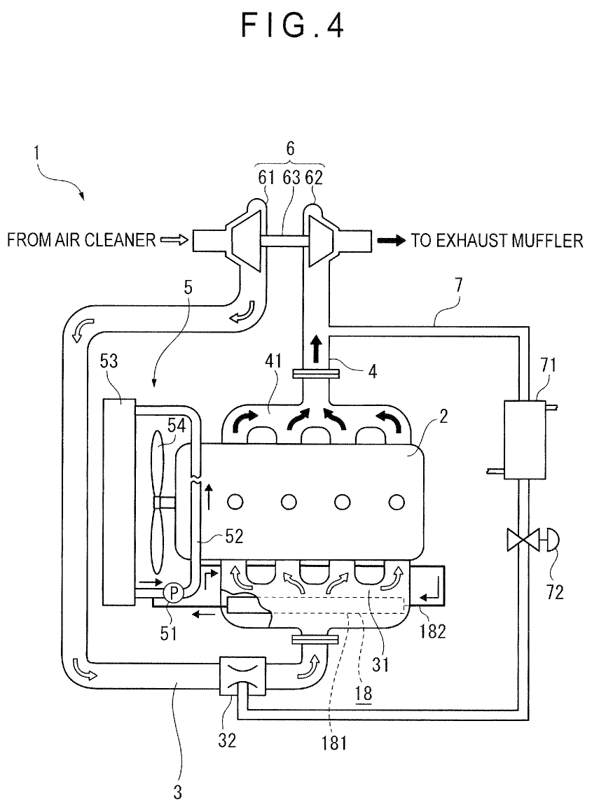

In contrast, as shown in FIG. 4, the liquid cooling system 18 according to the second embodiment differs from the liquid cooling system 8 in the first embodiment in that: a branch piping line 182 is provided to a portion of the piping line 52; and whereas cooling water of the engine-cooling coolant circulation line 5 of the diesel engine 1 is circulated in the piping line 52, the cooling water is delivered to a heat exchanger 181 through the branch piping line 182 by the pump 51.

In the embodiments a portion of the cooling water in the engine-cooling coolant circulation line 5 is delivered to the heat exchanger 181. Accordingly, the diameter of the branch piping line 182 is determined to be smaller than the diameter of the piping line 52, and the volume of the cooling water pumped into the piping line 182 is smaller than the volume of the cooling water pumped into the piping line 52.

Also, the heat exchanger 82 constituting the liquid cooling system 8 in the first embodiment is of the fin and tube type.

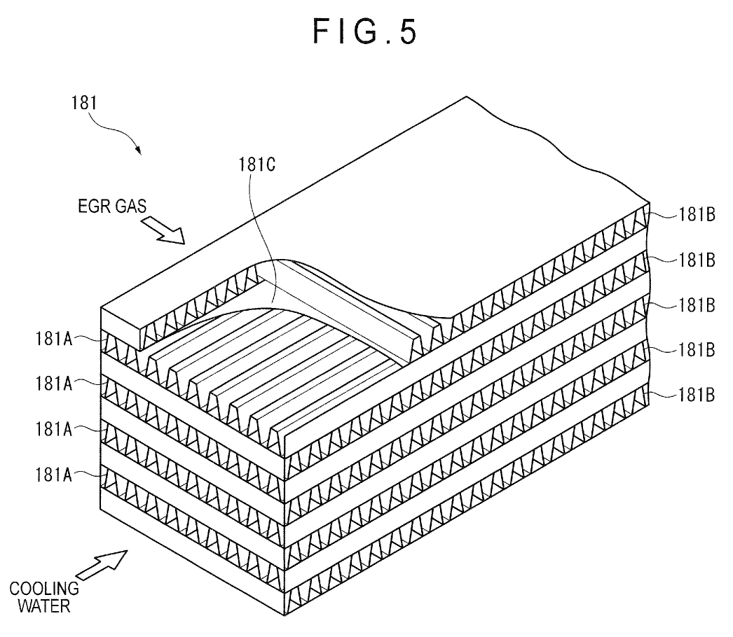

The heat exchanger 181 constituting the liquid cooling system 18 according to the second embodiment is different in employing the fin and plate type, as shown in FIG. 5.

More specifically, the heat exchanger 181 includes: a cooling water supplier 181A formed of a plurality of ribs extending in the same direction; and a gas supplier 181B having a plurality of ribs extending in a direction perpendicular to the extending direction of the ribs of the cooling water supplier 181A. The cooling water supplier 181A, which includes a plurality of cooling water suppliers 181A, and the gas supplier 181B, which includes a plurality of gas suppliers 181B, are layered on top of each other.

A heat conducting plate 181C divides the water supplier 181A and the gas supplier 181B. The cooling water flowing through the water supplier 181A and the EGR gas flowing through the gas supplier 181B undergo heat exchange with each other via the heat conducting plate 181C. Incidentally, the water supplier 181A, the gas supplier 181B, and the heat conducting plate 181C are made of similarly to the first embodiment, a corrosion-resistant material such as SUS304 or the like, and bonded by welding or the like to be integrated.

In addition to the basic effects described in the first embodiment, the following characteristic effects are obtained by the second embodiment on account of the differences.

In the liquid cooling system 18, the branch piping line 182 is branched from the piping line 52 of the engine-cooling coolant circulation line 5 of the diesel engine 1 to deliver cooling water to the heat exchanger 181. Accordingly, the radiator of the liquid cooling system 18 can also serve as the radiator 53 of the engine-cooling coolant circulation line 5 of the diesel engine 1. Therefore, the size of the liquid cooling system 18 is kept at a minimum in an accommodation space of the diesel engine 1 provided to a vehicle body and substantially encapsulated by dividing walls.

Also, the fin and plate type heat exchanger 181 allows heat exchange between the cooling water and the EGR gas via the entire heat conducting plate 181C, so that heat exchange can be efficiently conducted. Therefore, the cooling efficiency is improved.

### Third Embodiment

Next, a third embodiment of the present invention will be described.

In the above described first embodiment, the diesel engine 1 is equipped with a single turbocharger 6.

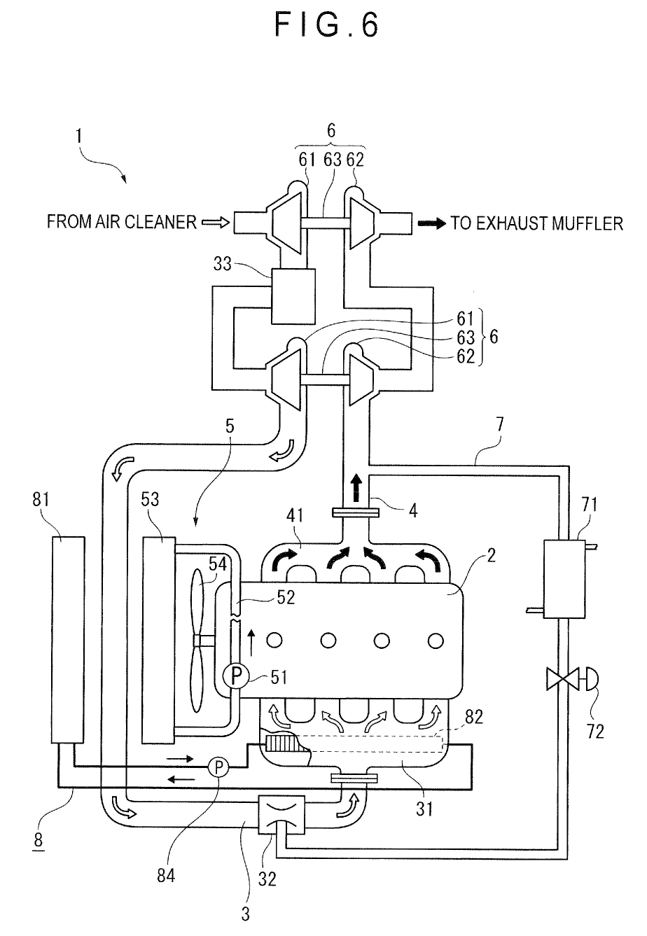

The third embodiment is different from the first embodiment in that as shown in FIG. 6, the diesel engine 1 is of twin turbo type equipped with double turbochargers 6

The third embodiment is different from the first embodiment also in that an ATAAC (air to air aftercooler) 33 of air cooling type is provided between the two turbochargers 6.

In addition to the basic effects described in the first embodiment, compression rate of gas delivered into the intake manifold 31 is increased by the double turbochargers 6 in the third embodiment, thereby improving the combustion rate. Also in the third embodiment, cooling of the intake line 3 is enhanced by the ATAAC 33 provided between the double turbochargers 6, so that temperature of the mixture delivered to the intake manifold 31 can be further lowered. Therefore, the EGR rate can be increased without hindering NOx reduction.

### Fourth Embodiment

Next, a fourth embodiment of the present invention will be described.

In the first embodiment, the EGR line 7 is provided with the EGR cooler for cooling the EGR gas delivered through the EGR line 7 from a side of the exhaust line 4 to a side of the intake line 3.

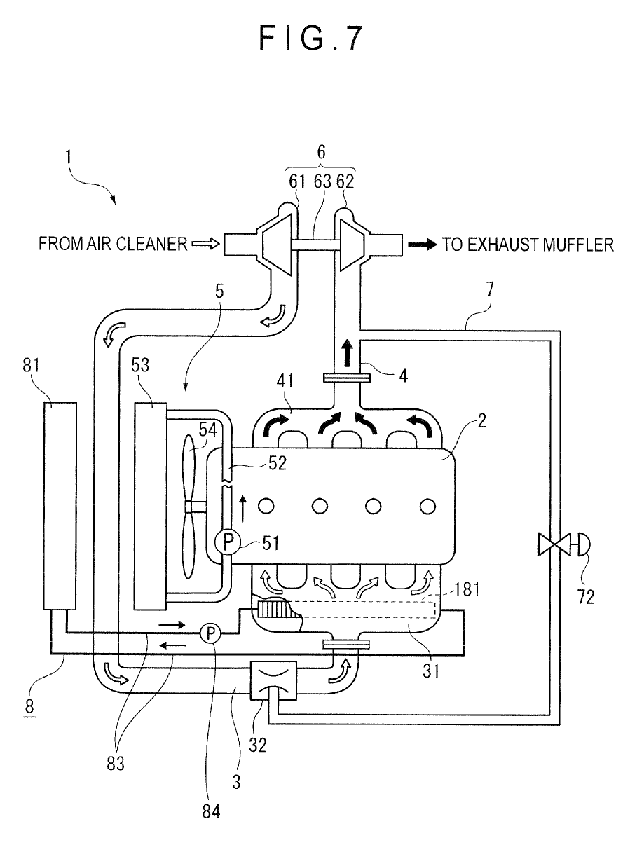

The fourth embodiment is different from the first embodiment in that the EGR line 7 is not provided with the EGR cooler, as shown in FIG. 7.

The mixture of the air delivered from the intake line 3 and the exhaust gas delivered from the EGR line 7 is cooled by the heat exchanger 181 provided to the intake manifold 31. The heat exchanger 181 has the same structure as the fin and plate type in the second embodiment shown in FIG. 5, so that the heat exchange efficiency with the mixture delivered to the intake manifold 31 is improved as compared to that in the first embodiment.

In addition to the basic effects described in the first embodiment, the EGR cooler 71 can be omitted to simplify the structure of the EGR line 7 in the fourth embodiment. Therefore, the EGR system can be downsized.

### Fifth Embodiment

Next, a fifth embodiment of the present invention will be described.

In the first and second embodiments described above, the heat exchanger constituting the liquid cooling cooler is equipped inside the intake manifold 31 of the diesel engine 1.

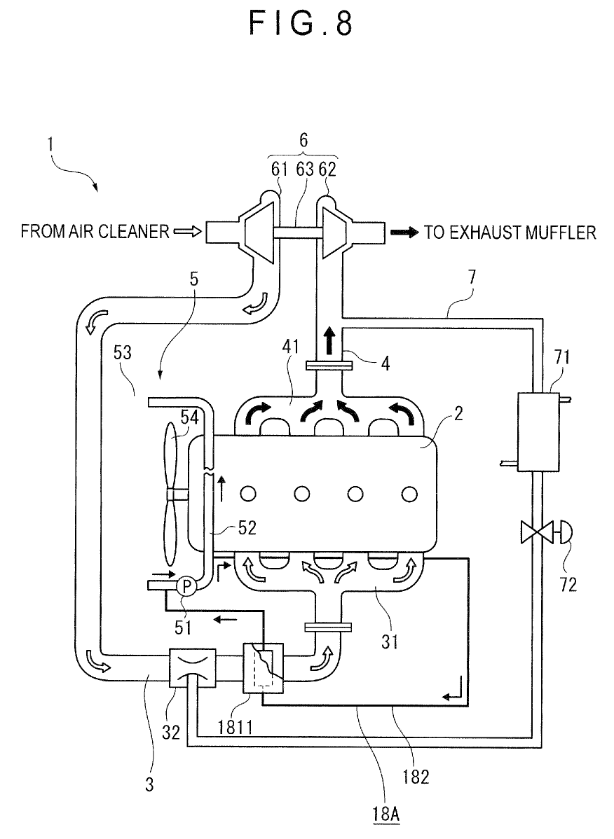

As shown in FIG. 8, the fifth embodiment is different from the first and second embodiments in that the heat exchanger 1811 (liquid cooling system 18A) is equipped to an intermediate portion of the intake line 3.

The heat exchanger 1811 is provided to downstream of the throttle 32 which mixes EGR gas delivered from the EGR line 7 and air delivered from the intake line 3, so that the mixture flowing through the intake line 3 is cooled in the intake line 3 before being delivered to the intake manifold 31. Incidentally, the heat exchanger 1811 has the same structure as the fin and plate type made of the same material as the second embodiment such as SUS304 or the like.

In addition to the basic effects described in the second embodiment, since the heat exchanger 1811 and the intake manifold 31 need not be integrally provided degree of freedom is improved as to positioning the heat exchanger 1811 in the fifth embodiment.

### Modifications of Embodiments

Note that the present invention is not limited to the above described embodiments, but includes the following modifications.

In the above embodiments, the heat exchangers 82, 181, and 1811 are made of a high corrosion-resistant material such as SUS304 or the like, but are not limited thereto. The heat exchanger may be produced with a steel material whose corrosion-resistance has been improved by chrome-plating or the like.

Also, the exhaust line 4 is not explicitly mentioned to be provided with a processor in the above embodiments, but may be provided with a DPF (Diesel Particulate Filter) or the like at a downstream side of the exhaust line, especially at a location subsequent to the turbocharger 6. In other words, a system in which PM (Particulate Matter) in the exhaust gas is removed may be provided.

Furthermore, the liquid cooling heat exchanger is of the fin and tube type in the first and third embodiments, but is not limited thereto, and may be of the fin and plate type respectively in each of the embodiments. On the contrary, the liquid cooling heat exchanger is of the fin and plate type in the second and fourth embodiments, but is not limited thereto, and may be of the fin and plate type respectively in each of the embodiments.

Also, in the second and fifth embodiments, the cooling water discharged from the pump 51 is delivered into the engine body 2 after being delivered to the heat exchangers 181 and 1811 via the branch piping line 182 branched from the piping line 52, but the present invention is not limited thereto. A straight pipe structure in which the cooling water discharged from the pump may be delivered to the engine body after being delivered to the heat exchanger to undergo heat exchange may be employed.

Other than what is described above, specific structures and shapes of the present invention may practically be any suitable structure or the like as far as an object of the present invention is achieved.

### INDUSTRIAL APPLICABILITY

The present invention can be employed for a diesel engine system utilized in construction machines such as a bulldozer, a hydraulic shovel, and the like, as well as for a diesel engine system utilized in trucking vehicles such as a dump truck and the like.

1. An exhaust gas recirculation system, comprising:
an exhaust line connected to an exhaust manifold of an engine;
an intake line connected to an intake manifold of the engine; and
an EGR line that intercommunicates the exhaust line and the intake line, wherein
a part of exhaust gas exhausted from the exhaust line is delivered to the intake line via the EGR line to be recirculated in the engine, and
a liquid cooling heat exchanger which is made of a corrosion-resistant material and has a circulation arrangement of cooling water independent of an engine-cooling coolant line is provided to downstream of an intersection with the EGR line in the intake line.

2. The exhaust gas recirculation system according to claim 1, wherein the liquid cooling heat exchanger is disposed inside the intake manifold.

3. The exhaust gas recirculation system according to claim 1, wherein an EGR cooler that cools the exhaust gas from the exhaust line is provided to the EGR line.

4. The exhaust gas recirculation system according to claim 1, wherein
a radiator that radiates heat of a cooling coolant to the exterior is connected to the liquid cooling heat exchanger via a heat exchanger-cooling coolant circulation line that delivers the coolant between the heat exchanger and the radiator, and
a circulation pump is provided to the heat exchanger-cooling coolant circulation line.

5. The exhaust gas recirculation system according to claim 1, wherein
a supercharger is provided to the intake line, and
the EGR line is connected to downstream of the intake line relative to the supercharger.

6. The exhaust gas recirculation system according to claim 2, wherein an EGR cooler that cools the exhaust gas from the exhaust line is provided to the EGR line.

7. The exhaust gas recirculation system according to claim 2, wherein
a radiator that radiates heat of a cooling coolant to the exterior is connected to the liquid cooling heat exchanger via a heat exchanger-cooling coolant circulation line that delivers the coolant between the heat exchanger and the radiator, and
a circulation pump is provided to the heat exchanger-cooling coolant circulation line.

8. The exhaust gas recirculation system according to claim 2, wherein
a supercharger is provided to the intake line, and
the EGR line is connected to downstream of the intake line relative to the supercharger.

9. The exhaust gas recirculation system according to claim 3, wherein
a supercharger is provided to the intake line, and
the EGR line is connected to downstream of the intake line relative to the supercharger.

10. The exhaust gas recirculation system according to claim 4, wherein
a supercharger is provided to the intake line, and
the EGR line is connected to downstream of the intake line relative to the supercharger.

11. The exhaust gas recirculation system according to claim 6, wherein
a supercharger is provided to the intake line, and
the EGR line is connected to downstream of the intake line relative to the supercharger.

12. The exhaust gas recirculation system according to claim 7, wherein
a supercharger is provided to the intake line, and
the EGR line is connected to downstream of the intake line relative to the supercharger.
